(19) United States
(12) Patent Application Publication
(10) Pub. No.: US 2013/0008182 A1
(43) Pub. Date: Jan. 10, 2013

(54) SELF-CONTAINED TEMPERATURE CONTROLLED APPARATUS

(76) Inventor: Brian Hrudka, Chapel Hill, NC (US)

(21) Appl. No.: 13/516,419

(22) PCT Filed: Dec. 16, 2010
(86) PCT No.: PCT/US2010/060834

§ 371 Date: Sep. 25, 2012

Related U.S. Application Data
(60) Provisional application No. 61/287,028, filed on Dec. 16, 2009.
(60) Provisional application No. 61/372,294, filed on Aug. 10, 2010.

(51) Int. Cl. F28F 27/00; H05B 1/00; F25B 21/02; F25B 49/00

(52) U.S. Cl. 62/3.6; 165/11.1; 62/126; 219/441

(57) ABSTRACT

A self-contained temperature controlled system and apparatus is disclosed. Example embodiments of the invention provide a system for operating a self-contained temperature controlled apparatus comprising at least one compartment, a predetermined temperature condition for the compartment, a sensor for detecting the temperature of the compartment, and at least one device for controlling the temperature of the compartment so that the predetermined temperature condition is met, wherein the system optionally comprises an on-board electrical power source. In some embodiments, the device for controlling the temperature of the compartment comprises an on-board refrigerant source.

### CROSS-REFERENCE

This application claims priority to U.S. provisional patent application Ser. No. 61/287,028, filed on Dec. 16, 2009, and U.S. provisional patent application Ser. No. 61/372,294, filed on Aug. 10, 2010, the contents of which are hereby incorporated by reference in their entirety.

### BACKGROUND

Self-contained devices which maintain their contents at or near specific temperatures are used widely for storage and transport of temperature sensitive items, as well as to maintain the specific temperature conditions which might be required to accelerate or decelerate the rates of chemical reactions. Examples of such items include picnic coolers and styrofoam shipping containers. The desired temperature of such devices is passively maintained using pre-cooled cooling packs, or pre-heated heating packs or refrigerants such as water ice or dry ice (frozen carbon dioxide).

Present passively heated or cooled temperature controlled devices suffer from a number of limitations. They are often inaccurate, only able to maintain an approximate temperature condition; and imprecise, unable to replicate temperature performance under varied conditions and over time. Both of these shortcomings are largely due to the fact that a passive temperature maintenance system is not structured to withstand large variations or fluctuations in ambient temperature.

For example, a passively cooled apparatus designed to keep a biological specimen at 4° C. using phase change cooling packs will perform differently under summer and winter ambient conditions, and will be incapable of preventing its payload from freezing under winter conditions. Items sensitive to temperature changes and/or to temperatures other than the desired condition may be negatively affected by exposure to inconsistent or variable temperatures, thus rendering presently available passive temperature controlled devices unsuitable for many tasks.

### SUMMARY

Example embodiments of the invention provide a temperature controlled apparatus wherein a predetermined temperature condition is actively maintained. In some embodiments, the temperature controlled apparatus comprises at least one compartment, a predetermined temperature condition for the compartment; a sensor for detecting the temperature of the compartment, and at least one device for affecting and/or controlling the temperature of the compartment so that the predetermined temperature condition is met. The apparatus optionally comprises an on-board electrical power source sufficient to meet the predetermined temperature condition over a range of ambient conditions and time.

In at least some embodiments, the predetermined temperature condition includes a target temperature and a unit of time for maintaining the target temperature.

In some embodiments, the temperature controlled apparatus comprises at least two compartments, wherein the temperature condition of each of the at least two compartments is independently controlled. In such embodiments, different temperature conditions can be maintained for each compartment so that the target temperature of each of the compartments and the unit of time for maintaining the target temperature of each of the compartments is controlled and maintained separately from the other compartment.

In at least some embodiments, the device for controlling the temperature condition is comprised of at least one of the group consisting of a liquid refrigerant evaporator, an electrical resistance heater, a heat exchange medium and a Peltier device. In some embodiments, the liquid refrigerant for the liquid refrigerant evaporator is stored in a pressure vessel within the apparatus. In some embodiments, the liquid refrigerant stored in the pressure vessel supplies liquid refrigerant to the evaporator at ambient temperature.

In some embodiments, the pressure vessel comprises an internal flexible siphon tube and a weighted intake, thus enabling the flexible siphon tube to draw liquid from the tank regardless of the spatial orientation of the device.

In some embodiments, the refrigerant is liquid carbon dioxide or supercritical carbon dioxide.

In some embodiments, the apparatus further comprises a component for collecting and storing digital temperature data from the compartment.

In some embodiments, the apparatus further comprises a digital microprocessor component to control temperature regulation functions.

In some embodiments, the apparatus further comprises a connection for connecting to an external source of the refrigerant.

In some embodiments, the compartment holds a perishable item. In some embodiments, the perishable item is selected from the group consisting of food, biological samples, medications, therapeutic agents, diagnostic agents, antisera, antibodies, blood products, vaccines, DNA therapies, eggs, semen, fertilized embryos, human cell lines, animal cell lines, and tissue samples for diagnostic or therapeutic use.

Example embodiments of the invention provide a temperature controlled apparatus comprising at least one compartment, means for predetermining a temperature condition for the compartment; means for detecting the temperature of the compartment; and means for controlling the temperature of the compartment so that the predetermined temperature condition is met.

In some embodiments, the temperature condition includes a target temperature and a unit of time for maintaining the target temperature.

In some embodiments, the temperature controlled apparatus further comprises means for collecting and storing temperature data from the compartment.

In some embodiments, the temperature controlled apparatus further comprises means for controlling temperature regulation functions.

Example embodiments of the invention provide a method of maintaining a self-contained temperature controlled apparatus comprising providing at least one compartment; placing at least one item in the compartment; providing a predetermined temperature condition for the compartment; detecting the temperature of the compartment; and affecting or adjusting the detected temperature of the compartment to meet the predetermined temperature condition, wherein the apparatus optionally comprises an on-board electrical power supply sufficient to meet the predetermined temperature condition.

In some embodiments, the temperature condition includes a target temperature and a unit of time for maintaining the target temperature.

In some embodiments, the method of maintaining the temperature controlled apparatus further comprises collecting and storing temperature data from the compartment.

In some embodiments, the method of maintaining the temperature controlled apparatus comprises providing at least two compartments, wherein the temperature condition of each of the at least two compartments is independently controlled. In such embodiments, different temperature conditions can be maintained for each compartment so that the target temperature of each of the compartments and the unit of time for maintaining the target temperature of each of the compartments is controlled and maintained separately from the other compartment.

In at least some embodiments, the device for controlling the temperature condition is comprised of at least one of the group consisting of a liquid refrigerant evaporator, an electrical resistance heater, a heat exchange medium and a Peltier device. In some embodiments, the liquid refrigerant for the liquid refrigerant evaporator is stored in a pressure vessel within the apparatus. In some embodiments, the liquid refrigerant stored in the pressure vessel supplies liquid refrigerant to the evaporator at ambient temperature.

In some embodiments, the pressure vessel comprises an internal flexible siphon tube and a weighted intake, thus enabling the flexible siphon tube to draw liquid from the tank regardless of the spatial orientation of the device.

In some embodiments, the refrigerant is liquid carbon dioxide or supercritical carbon dioxide.

In some embodiments, the method of maintaining the temperature controlled apparatus further comprises providing a digital microprocessor component to control temperature regulation functions.

In some embodiments, the item placed in the compartment is a perishable item. In some embodiments, the perishable item is selected from the group consisting of food, biological samples, medications, therapeutic agents, diagnostic agents, antisera, antibodies, blood products, vaccines, DNA therapies, eggs, semen, fertilized embryos, human cell lines, animal cell lines, and tissue samples for diagnostic or therapeutic use.

Example embodiments of the invention provide a system for operating a self-contained temperature controlled apparatus comprising at least one compartment, a predetermined temperature condition for the compartment, a sensor for detecting the temperature of the compartment, at least one device for controlling the temperature of the compartment so that the predetermined temperature condition is met; and optionally, an electrical power source. In some embodiments, the electrical power source is at least one of an on-board source or a connection for connecting to an external electrical power source. In some embodiments, the electrical power source is a rechargeable battery.

In at least some embodiments, the device for controlling the temperature condition is comprised of at least one of the group consisting of a liquid refrigerant evaporator, an electrical resistance heater and a Peltier device. In some embodiments, the liquid refrigerant for the liquid refrigerant evaporator is stored in a pressure vessel within the apparatus. In some embodiments, the liquid refrigerant stored in the pressure vessel supplies liquid refrigerant to the evaporator at ambient temperature.

In some embodiments of the system, the refrigerant is selected from the group consisting of liquid carbon dioxide, supercritical carbon dioxide, dry ice, halocarbons (such as Freon®) and liquid nitrogen.

In at least some embodiments of the system, the predetermined temperature condition includes a target temperature and a unit of time for maintaining the target temperature.

In some embodiments, the system comprises at least two compartments, wherein the temperature condition of each of the at least two compartments is independently controlled. In such embodiments, different temperature conditions can be maintained for each compartment so that the target temperature of each of the compartments and the unit of time for maintaining the target temperature of each of the compartments is controlled and maintained separately from the other compartment.

In at least some embodiments, the device for controlling the temperature condition is comprised of at least one of the group consisting of a liquid refrigerant evaporator, an electrical resistance heater and a Peltier device. In some embodiments, the liquid refrigerant is stored in a pressure vessel within the apparatus. In some embodiments, the liquid refrigerant stored in the pressure vessel supplies liquid refrigerant to the evaporator at ambient temperature.

In some embodiments, the pressure vessel comprises an internal flexible siphon tube and a weighted intake, thus enabling the flexible siphon tube to draw liquid from the tank regardless of the spatial orientation of the device.

In some embodiments, the refrigerant is liquid carbon dioxide or supercritical carbon dioxide.

In some embodiments, the system further comprises a connection for connecting to an external source of the refrigerant.

In some embodiments, the system further comprises a component for collecting and storing digital temperature data from the compartment.

In some embodiments, the system further comprises a digital microprocessor component to control temperature regulation functions.

In some embodiments, the compartment holds a perishable item. In some embodiments, the perishable item is selected from the group consisting of food, biological samples, medications, therapeutic agents, diagnostic agents, antisera, antibodies, blood products, vaccines, DNA therapies, eggs, semen, fertilized embryos, human cell lines, animal cell lines, and tissue samples for diagnostic or therapeutic use.

### BRIEF DESCRIPTION OF THE DRAWINGS

FIGS. 1A and 1B show a two-dimensional and three-dimensional cross-sectional view of the system, respectively, with basic internal components according to an example embodiment of the invention.

FIG. 2 depicts the liquid refrigerant storage pressure vessel in cross section according to an example embodiment of the invention.

FIG. 3 depicts the liquid refrigerant storage pressure vessel in cross section and in eight possible different spatial positions according to example embodiments of the invention.

FIG. 4 depicts an exploded, two-dimensional, cross-sectional view of a compartment according to example embodiments of the invention.

### DETAILED DESCRIPTION

The following detailed description refers to the accompanying drawings, which illustrate specific embodiments of the invention. Other embodiments having different structures and operation do not depart from the scope of the present invention.

Embodiments of the invention are described with reference to drawings included herewith. Like reference numbers refer to like structures throughout. It should be noted that the drawings are schematic in nature. Not all parts are always shown to scale. The drawings illustrate but a few specific embodiments of the invention.

Embodiments of the present invention provide a self-contained temperature controlled apparatus and system wherein a predetermined temperature condition is actively maintained. In some embodiments, the temperature controlled apparatus comprises at least one compartment, a predetermined temperature condition for the compartment; a sensor for detecting the temperature of the compartment, and at least one device for controlling the temperature of the compartment so that the predetermined temperature condition is met, wherein the apparatus optionally comprises an on-board electrical power source sufficient to meet the predetermined temperature condition.

The term “self-contained” describes the ability of the apparatus and system to generate and/or maintain the predetermined temperature condition without any assistance from components such as power or energy sources that are located outside of, or external to, the apparatus. Examples of external power sources include, but are not limited to, an electrical socket in a large electrical system, such as that which would be found in buildings, and internal combustion engine powered generators. Examples of on-board electrical power sources include, but are not limited to, batteries, fuel cells, and internal combustion engine driven generators.

The apparatus comprises at least one device for controlling the temperature of the compartment so that the predetermined temperature condition is met. Examples of devices for controlling and/or affecting the temperature include, but are not limited to, a liquid refrigerant evaporator, a Peltier device, and an electrical resistance heater.

A sensor is used to detect the temperature of the compartment. In some embodiments, the sensor is a thermometer, bimetallic strip or thermocouple. In some embodiments, a thermostat is used for sensing and controlling temperature.

The self-contained nature of the apparatus makes it well-suited for shipping items that are temperature sensitive. The fact that the apparatus is self-contained does not preclude the apparatus having features that allow it to connect into larger stationary systems or power sources, such as having a facility to attach to a standard household 120 VAC (volts alternating current) electrical outlet. Another way to refer to the self-contained nature of the apparatus is to state that all of the required resources for maintaining a predetermined temperature condition are “on-board” the apparatus. The term “on-board” refers to components of the apparatus that provide a power, energy or refrigerant source for heating and/or cooling the compartment. Note that on-board resources are present in a finite amount and can be exhausted if used over a period of time.

In one example, the apparatus is used as a temperature controlled storage unit supplied with electrical power and/or liquid refrigerant from an external source. However, the apparatus of the invention is self-contained and can maintain the predetermined temperature condition with its own on-board resources. This means that the apparatus is well-suited for storage of items that are temperature sensitive, and the apparatus can be used with both a stationary electric power (such as 120VAC power) and liquid refrigerant source (such as a large stationary tank) and an internal power source (such as a battery) and/or liquid refrigerant source (such as an internal pressure storage cylinder) to insure maintenance of the predetermined temperature condition.

It is understood by those of ordinary skill in the art that the device for controlling the temperature of the compartment will in some embodiments be powered by an electrical power source but in other embodiments will not require electrical power, depending on the specifications of the device. The source of electrical power is optional and is based on the nature of the device used.

Thus, in some embodiments, a source of electrical power is used to meet the predetermined temperature condition. An apparatus that accomplishes heating and cooling by use of a Peltier device, for example, requires an electrical power supply such as a battery. In some embodiments, a supply of liquid refrigerant in a pressurized vessel is sufficient for meeting the predetermined temperature condition. In some embodiments, both an electrical power supply for powering a Peltier device and for controlling or operating a liquid refrigerant evaporator are provided on-board the apparatus.

In at least some embodiments, the apparatus maintains the predetermined temperature condition in any spatial orientation. There is no requirement that it remain upright or in any other specific spatial orientation in order to maintain the predetermined temperature condition. Thus, the apparatus is ideally suited for transport of temperature sensitive items. The apparatus maintains or substantially maintains a predetermined temperature condition even when it is rolling around in a moving vehicle or gets turned upside down.

The phrases “predetermined temperature condition” or “temperature condition” are used herein to refer to the temperature and time settings programmed into the apparatus for a given payload, or for consumption of current on-board resources, or for any other specific situation for which the apparatus is to be used. The temperature condition, or predetermined temperature condition, refers to any instructions provided to the apparatus and system of the invention regarding maintenance of compartment temperature for a unit of time.

The term “payload” as used herein refers to any item or sample placed within a compartment of the apparatus. In at least some embodiments, the predetermined temperature condition includes a target temperature and a unit of time for maintaining the target temperature. In some embodiments, the predetermined temperature condition is set at a constant, or fixed, temperature. An example of a fixed predetermined temperature condition is a setting requiring a single temperature, such as −20 C, for a unit of time such as 48 hours.

In some embodiments, the predetermined temperature condition is variable. In some embodiments, the variable predetermined temperature condition is a schedule of a plurality of target temperatures and units of time for maintaining each of the plurality of target temperatures. The plurality of target temperatures and units of time might be, for example, programs for initiating or retarding chemical reactions such as enzymatic degradations or syntheses.

The apparatus maintains or substantially maintains the predetermined temperature condition even when the ambient temperature is above and/or below the predetermined temperature condition.

The temperatures dictated by the predetermined temperature condition of the apparatus can be any temperature within the range of −70° C. to 50° C., inclusive. In some embodiments, the temperature range within a compartment is −70° C. to 50° C., inclusive. In some embodiments, the temperature range within a compartment is −70° C. to 37° C., inclusive. In some embodiments, the temperature range in a compartment is −20° C. to 37° C., inclusive. In some embodiments, the temperature range in a compartment is −70° C. to 15° C., inclusive. In some embodiments, the temperature range in a compartment is −70° C. to 4° C., inclusive. In some embodiments, the temperature range in a compartment is −20° C. to 15° C., inclusive.

In some embodiments, the predetermined temperature in a compartment is fixed at −70° C. In some embodiments, the temperature is fixed at −20° C. In some embodiments, the predetermined temperature is fixed at 4° C. In some embodiments, the predetermined temperature is fixed at 15° C. In some embodiments, the predetermined temperature is fixed at 37° C.

In some embodiments, the predetermined temperature condition range within a compartment is variable. The predetermined temperature condition is a plurality of temperatures, wherein each temperature is held for a specific unit of time. Such variable temperature conditions are used, for example, to carry out an enzymatic reaction on a biological sample. In one example, the predetermined temperature condition is set to 37° C. to carry out an enzymatic reaction for a specific unit of time (i.e., one hour or two hours) and then the temperature condition is set to lower to 4° C. to stop the enzymatic reaction and hold the biological sample at 4° C. for a period of time until the sample can be transferred to the next reaction step. In another example, the predetermined temperature condition is set to 37° C. for a specific amount of time, and then the temperature condition is set to freeze the sample, so the temperature drops to −20° C. or −70° C. for a second specified amount of time.

In some embodiments, the temperature controlled apparatus comprises at least two compartments, wherein the temperature condition of each of the at least two compartments is independently controlled. In such embodiments, different temperature conditions can be maintained for each compartment. In some embodiments, the temperature controlled apparatus comprises at least three compartments, at least four compartments, at least five compartments, at least six compartments, at least seven compartments, at least eight compartments, at least nine compartments, or at least ten compartments. The number of compartments is not meant to be limiting, and one of ordinary skill in the art understands that different numbers of compartments can be used within the scope of the presently claimed invention. Since the temperature condition of each of the at least two compartments is separately and independently controlled, any compartments unused at a particular time can remain latent. Leaving the unused compartments in a latent state saves on-board resources in the self-contained temperature controlled apparatus, and maximizes the utility of an apparatus comprising more than one compartment.

In one example, an apparatus comprises three compartments. A first compartment has a predetermined fixed temperature of −70° C. A second compartment has a predetermined fixed temperature of −20° C. A third compartment has a predetermined fixed temperature of 4° C. In another example, an apparatus comprises two compartments. One compartment has a predetermined fixed temperature of −70° C. A second compartment has a predetermined fixed temperature of −20° C. In still another example, an apparatus comprises two compartments. One compartment has a predetermined fixed temperature of −20° C. A second compartment has a predetermined fixed temperature of 4° C. In yet another example, an apparatus comprises two compartments. One compartment has a predetermined fixed temperature of −70° C. A second compartment has a predetermined fixed temperature of 4° C.

In still another example, an apparatus comprises three compartments but only one compartment is in use to hold items. A first compartment containing the items has a predetermined fixed temperature of −20° C. A second compartment and a third compartment each has a latent predetermined temperature condition, as neither of them contains any items.

In some embodiments, the temperature controlled apparatus has at least two compartments, wherein at least one of the compartments has a predetermined temperature condition that comprises a variable temperature. Thus, in one example, an apparatus with two compartments has one compartment at a fixed temperature of −70° C. and a second compartment with a variable temperature, such that the temperature of the second compartment is 37° C. for a first period of time and then changes to 4° C. for a second period of time. The examples of fixed and variable temperatures for the predetermined temperature conditions are not meant to be limiting, and one of ordinary skill in the art understands that any different combinations of temperature conditions from −70° C. to +50° C. inclusive can be used within the scope of the presently claimed invention.

In some embodiments, the device for controlling the temperature condition is comprised of at least one of the group consisting of a liquid refrigerant evaporator, an electrical resistance heater and a Peltier device. In one embodiment, the apparatus comprises a liquid refrigerant evaporator. In another embodiment, the apparatus comprises an electrical resistance heater. In another embodiment, the apparatus comprises a Peltier device. In still another embodiment, the apparatus comprises a liquid refrigerant evaporator and an electrical resistance heater. In another embodiment, the apparatus comprises a liquid refrigerant evaporator and a Peltier device. In yet another embodiment, the apparatus comprises a liquid refrigerant evaporator, an electrical resistance heater and a Peltier device

As used herein, the term “Peltier device” refers to heating or cooling of a compartment or chamber using the Peltier effect to create a heat flux between the junction of two different types of materials. A Peltier cooler, heater, or thermoelectric heat pump is a solid-state active heat pump which transfers heat from one side of the device to the other side against the temperature gradient (from cold to hot), with consumption of electrical energy. Such an instrument is also called a Peltier heat pump, solid state refrigerator, or thermoelectric cooler. Use of the Peltier effect to heat and/or cool is also referred to as thermoelectric heating and/or cooling.

In some embodiments, the refrigerant is carbon dioxide. In some embodiments, the carbon dioxide is in liquid form and is stored in a pressure vessel, or tank, wherein the carbon dioxide pressure vessel, or tank, comprises a weighted intake attached to a flexible siphon tube. In some embodiments, the liquid carbon dioxide is in a supercritical state. In some embodiments, the device for controlling the temperature condition is comprised of a refrigerant other than liquid carbon dioxide. Examples of refrigerants other than carbon dioxide include, but are not limited to, halocarbons, liquid nitrogen or dry ice (which is the solid state of carbon dioxide).

In at least some embodiments, a heat exchange medium is used. Heat exchange media are comprised of any material that transfers heat between the sample or payload and a heating or refrigeration source such as, but not limited to, an electrical resistance heater, a Peltier device or a liquid refrigerant evaporator. The heat exchange medium can be a solid, liquid or gas.

In some embodiments, the liquid refrigerant is evaporated to its gaseous phase, absorbing heat in the phase change process. Payload heat can be absorbed by this evaporation via a metallic heat exchanger, the cold gaseous phase of the refrigerant, or via a liquid heat exchange medium such as ethylene glycol. In some embodiments, a water/glycol or water/alcohol or alcohol heat exchange system between payloads is used, controlled with micro-pumps and micro-valves, wherein the water/glycol or water/alcohol or alcohol heat exchange system are examples of a liquid heat exchange medium.

In some embodiments, the stored item or heat exchange medium is cooled by a Peltier device. In some embodiments, the stored item or heat exchange medium is heated by a Peltier device or electrical resistance heater.

Other cooling systems and enhancements can be used in the device for controlling the temperature condition of compartments of the apparatus. In some embodiments, a refrigerant particulate filter is used to prevent evaporator malfunction due to clogging of the expansion valve or orifice or capillaries.

In some embodiments, a spherical or spheroid liquid refrigerant pressure or storage vessel is used rather than a cylindrical pressure or storage vessel with one or two hemispherical ends.

In some embodiments, the apparatus further comprises an on-board refrigeration system (thermoelectric or mechanical gas compression and expansion cycle) powered by a 120VAC to provide pre-cooling and pre-transit refrigeration resource without consumption of on-board refrigerant.

In some embodiments, the apparatus further comprises a connector for connecting to an external “accessory refrigeration device” (thermoelectric or mechanical refrigeration on 120VAC power) which provides pre-cooling or post-cooling/pre-shipment refrigeration resources to at least one apparatus via liquid (e.g., water/glycol) heat exchange.

In some embodiments, the apparatus further comprises a connector for connecting to an external refrigerant source, such as a large stationary carbon dioxide cylinder with siphon tube to provide liquid carbon dioxide to the apparatus for pre-cooling or post-cooling/pre-shipment refrigeration without consumption of internal, or on-board, resources.

In some embodiments, the apparatus further comprises an on-board transformer to convert 120VAC to low voltage direct current to maintain internal battery charge during storage at user location.

In some embodiments, the apparatus employs an electrical resistance heater to increase the temperature of stored items directly or via a heat exchange medium such as water/alcohol or water/glycol.

In some embodiments, the apparatus further comprises a digital component. In some embodiments, the digital component enables input of a temperature condition via a user interface, thus providing a predetermined temperature condition. In some embodiments, the digital component enables collecting and storing temperature data from the compartment. In such embodiments, the digital component captures the temperature history of the apparatus over a period of time. In some embodiments, the digital component provides a comprehensive temperature history for all items in the apparatus from the time they are placed in the apparatus until the time they are removed from the apparatus. Such history can be extremely important for quality control purposes.

Some embodiments comprise further security measures, such as use of an on-board RFID chip for external identification of the contents of the apparatus and/or use of an on-board GPS locator system with cellular telephone connectivity for locating and/or tracking the apparatus, for example while in transit from one location to another.

In some embodiments, the apparatus is received by a user with the temperature condition predetermined and preset. In some embodiments, the apparatus is received by the user with armamentarium customized to the user's sample requirements. The term “armamentarium” refers to everything needed for the complete process of using the apparatus, including, but not limited to, sample acquisition devices, test kits, stabilizers, preservatives, reagents, and containers for placing the sample in the compartment of the apparatus, and including the apparatus itself. The armamentarium is comprised of anything that is used to obtain and store the sample, payload or item(s) in the self-contained temperature controlled apparatus and system. The components of the armamentarium differ with the nature of the item, sample or payload to be placed in the compartment of the apparatus.

In some embodiments, the apparatus is received by the user with armamentarium but without a preset temperature condition. In such cases, the apparatus receives temperature condition input from the user via a user interface.

In some embodiments, the apparatus further comprises a digital component for storing digital data regarding the sample. In some embodiments, the digital data regarding the sample includes informational data regarding the origin of the sample or other data describing the nature of the sample. In cases where the sample is a medical sample from a patient, the digital data comprises information about the patient. Patient information includes the patient's identifying information and medical information. The medical information stored is of any type that can be captured in a digital form, including text and images. Examples of medical information include digital radiographic images, EKGs, physician notes, full medical history and test results.

In some embodiments, the apparatus further comprises a digital component that utilizes a biometric fingerprint reader, retinal scanner, or other biometric tools to obtain secure patient or sample handler identification data.

The compartment of the self-contained temperature controlled system and apparatus is constructed to hold the payload. The term “payload” as used herein refers to an item placed in the compartment of the apparatus. The item or payload is also referred to as a sample. In some embodiments, the payload, sample, or item is perishable.

In some embodiments, the perishable item, sample, or payload is selected from the group consisting of food, biological samples, medications, antibodies, blood products, vaccines, DNA therapies, eggs, semen, fertilized embryos, human cell lines, animal cell lines, and tissue samples for diagnostics or therapeutics. In some embodiments, the compartment holds human donor tissue for surgical purposes.

The self-contained temperature controlled apparatus can be used to transport or store items. In some embodiments, the apparatus is used to transport perishable items. In some embodiments, the apparatus is used to store perishable items.

In at least some embodiments, the structure of the compartment is maximized to maintain the predetermined temperature condition, even upon exposure to varying ambient conditions. In some embodiments, the compartment is comprised of a solid or porous (sintered) aluminum or stainless steel or brass insert to optimize weight and coolant heat exchange efficiency trade-off.

Variations in the construction of the compartment occur amongst various embodiments of the apparatus but all still fall within the scope of the invention. Characteristics affecting construction of the compartment include the nature of the payload and its temperature requirements, as well as the size and fragility of the payload. In some embodiments, the compartment is a cavity within the apparatus. In some embodiments, the payload is placed in a payload container inside the compartment. In some embodiments, the payload is placed in a payload insert within a payload container inside the compartment. In some embodiments, the payload is placed in a vial within a payload insert within a payload container inside the compartment. Payload containers, vials, and inserts help to secure the payload within the compartment, and help to insulate and protect the payload from physical shock or damage. Payload containers, vials, and inserts can further be constructed to assist with maintaining the predetermined temperature condition desired for the payload by providing thermal density or conductivity.

In at least some embodiments, a vessel is used as a payload container to hold an item in the compartment of the apparatus. In some embodiments, the vessel is insulated. In some embodiments, the vessel is a Thermos® vessel. A Thermos® vessel is an insulated vessel, wherein the insulating occurs at least partly from a vacuum between an inner and outer wall of the vessel. A Thermos® vessel can be made out of a variety of different materials, such as metal and plastic. In some embodiments, the Thermos® vessel is a Dewar flask. In some embodiments, the internal cavity of the Dewar flask is altered to maximize sample reception. In some embodiments, heat exchange on the external surface of the Thermos® vessel is used to reduce heat flow into the payload container to improve cooling system efficiency.

In at least some embodiments, a vial containing a sample or payload item is housed within the payload container within a payload container insert. In some embodiments, the insert is comprised of a solid or porous metallic, plastic or ceramic material. In some embodiments, the insert is comprised of a metallic, plastic or ceramic material of high thermal density. In some embodiments the metallic material may be sintered aluminum or stainless steel or brass insert to optimize the efficiency of heat exchange between the sample and the heating source such as electrical resistance heater or cooling source such as refrigerant evaporator.

In at least some embodiments, the payload container comprises a closure mechanism. Examples of compartment closure systems include, but are not limited to, threaded, pressure-fitted, and hinged closure mechanisms. In some embodiments, the closure mechanism includes a latch or lock to insure security during transport.

In some embodiments of an apparatus with at least two compartments, the payload container comprises a closure mechanism that provides a positive gas seal to allow internal compartment pressure to reach ca. 1-50 psi above atmospheric pressure to drive gas flow to other payload containers including those in other compartments.

Different types of valves are utilized in and with the temperature controlled apparatus. In some embodiments of the apparatus, the refrigeration device employs an electronically controlled and electromechanically actuated refrigerant expansion valve. In some embodiments of the apparatus, the refrigeration device employs a thermostatic expansion valve.

In some embodiments of the invention, pneumatic expansion valve actuation is used. In such embodiments, a gas pressure regulator is used to provide medium pressure refrigerant gas to operate the pneumatic actuator via an electromechanical valve.

In some embodiments of the invention, an electromechanical expansion valve actuator is used. In such embodiments, a solenoid or motor actuates the expansion valve.

In some embodiments, a fixed-aperture expansion orifice is used for liquid refrigerant expansion. In such embodiments, refrigeration is controlled by a liquid refrigerant on/off valve which may be manually or electromechanically actuated.

In some embodiments, a series of capillary tubes of increasing diameter is used as a liquid-to-gas expansion mechanism and heat exchanger. In some embodiments, the series is used in conjunction with a fixed-aperture orifice or variable-aperture refrigerant flow control valve.

Some embodiments of the apparatus comprise a variable-aperture needle expansion valve controlled by rotary actuator or motor.

In some embodiments, a pressure regulator with a bleed valve on the refrigerant gas exit connection from a −70° C. payload container is used to maintain an appropriate internal pressure between 1 and 50 psi above atmospheric pressure.

In some embodiments, the apparatus comprises an insulated vessel as a payload container with an internal expansion valve which is operated via an actuator shaft connected to an external actuator operated electromechanically or pneumatically.

In some embodiments, a refrigerant evaporator is located outside the compartments and payload containers, using a water/glycol or water/alcohol heat exchange system driven by electrically operated pumps and controlled by electrically operated valves. In some embodiments, the water/glycol or water alcohol pumps and valves are operated by pressurized waste refrigerant gas.

In some embodiments, the apparatus comprises pressure sealing of the apparatus' external casing, allowing waste refrigerant gas to create positive pressure within the apparatus to prevent incursion of external humid air into the apparatus thus avoiding condensation or freezing of water within the refrigerated compartments of the apparatus.

In some embodiments, the refrigerant used with the apparatus comprises liquid nitrogen stored at its boiling point at a pressure of atmospheric pressure plus 1-50 psi in a vessel which vents only cold nitrogen gas in any spatial orientation of the vessel.

Example embodiments of the invention provide a method of maintaining a temperature controlled apparatus comprising: providing at least one compartment, providing a predetermined temperature condition for the compartment; detecting the temperature of the compartment; and adjusting the detected temperature of the compartment to meet the predetermined temperature condition, wherein the apparatus optionally comprises an on-board power source sufficient to meet the predetermined temperature condition.

In some embodiments, the temperature condition includes a target temperature and a unit of time.

In some embodiments, the method of maintaining a temperature controlled apparatus further comprises collecting and storing temperature data from the compartment.

Example embodiments of the invention provide a system for operating a self-contained temperature controlled apparatus comprising at least one compartment, a predetermined temperature condition for the compartment, a sensor for detecting the temperature of the compartment, at least one device for controlling the temperature of the compartment so that the predetermined temperature condition is met; and optionally, an electrical power source. In some embodiments, the electrical power source is at least one of an on-board power source or connected to an external power source. The self-contained temperature controlled apparatus of the system is comprised of any of the embodiments described hereinabove.

In at least some embodiments, the system is reusable. In at least some embodiments, the system is rechargeable and reprogrammable. In some embodiments the device for controlling the temperature of the compartment is an on-board, or internal, refrigerant cylinder that is replaceable or rechargeable. In some embodiments, the on-board, or internal, electrical power supply is a battery that is replaceable or rechargeable. Thus, in at least some embodiments, the apparatus and system are reusable, which results in both cost savings and reduced waste. In some embodiments, the system is reprogrammable so that the predetermined temperature condition can be reset as desired. Thus, in at least some embodiments, the system is reusable, rechargeable and reprogrammable.

In some embodiments of the self-contained temperature controlled system, the on-board, or internal, electrical power supply is used to heat the stored items using electrical resistance heating or a Peltier device. In some embodiments, an on-board, or internal, electrical power supply is used to power the temperature control mechanisms comprised of digital data processing device, temperature sensors and electromechanical devices such as pumps, motors and valves. In some embodiments, on-board, or internal, electric power is used to operate a visual display or touchscreen or other user interface device which allows the user to enter temperature program or other data into the apparatus.

In some embodiments of the system, the refrigerant is selected from the group consisting of liquid carbon dioxide, supercritical carbon dioxide, halocarbons including haloalkanes, dry ice, and liquid nitrogen.

In at least some embodiments of the system, the predetermined temperature condition includes a target temperature and a unit of time for maintaining the target temperature.

In some embodiments, the system comprises at least two compartments, wherein the temperature condition of each of the at least two compartments is independently controlled. In such embodiments, different temperature conditions can be maintained for each compartment so that the target temperature of each of the compartments and the unit of time for maintaining the target temperature of each of the compartments is controlled and maintained separately from the other compartment.

In at least some embodiments, the device for controlling the temperature condition of the system is comprised of at least one of the group consisting of a liquid refrigerant evaporator, an electrical resistance heater and a Peltier device. In some embodiments, the liquid refrigerant is stored in a pressure vessel within the apparatus. In some embodiments, the liquid refrigerant stored in the pressure vessel supplies liquid refrigerant to the evaporator at ambient temperature.

In some embodiments, the pressure vessel comprises an internal flexible siphon tube and a weighted intake, thus enabling the flexible siphon tube to draw liquid from the tank regardless of the spatial orientation of the apparatus.

In some embodiments, the refrigerant is liquid carbon dioxide or supercritical carbon dioxide.

In some embodiments, the system further comprises a component for collecting and storing digital temperature data from the compartment.

In some embodiments, the system further comprises a digital microprocessor component to control temperature regulation functions.

In some embodiments, the compartment holds a perishable item. In some embodiments, the perishable item is selected from the group consisting of food, biological samples, medications, therapeutic agents, diagnostic agents, antisera, antibodies, blood products, vaccines, DNA therapies, eggs, semen, fertilized embryos, human cell lines, animal cell lines, and tissue samples for diagnostic or therapeutic use.

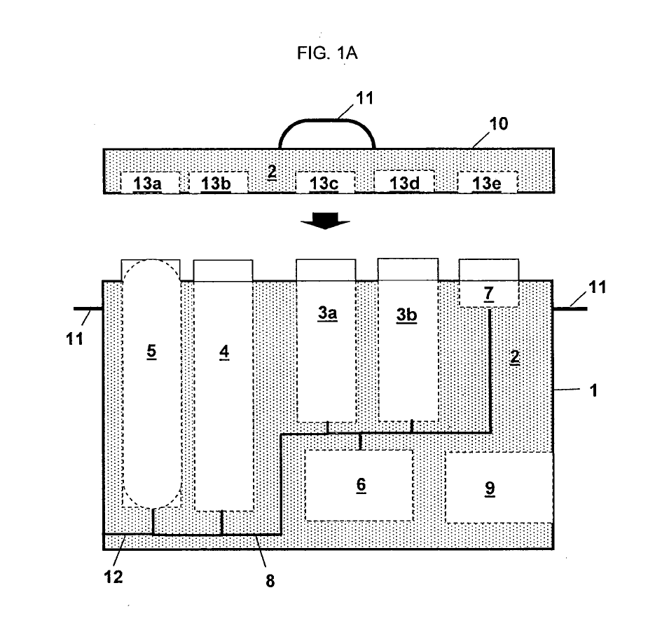

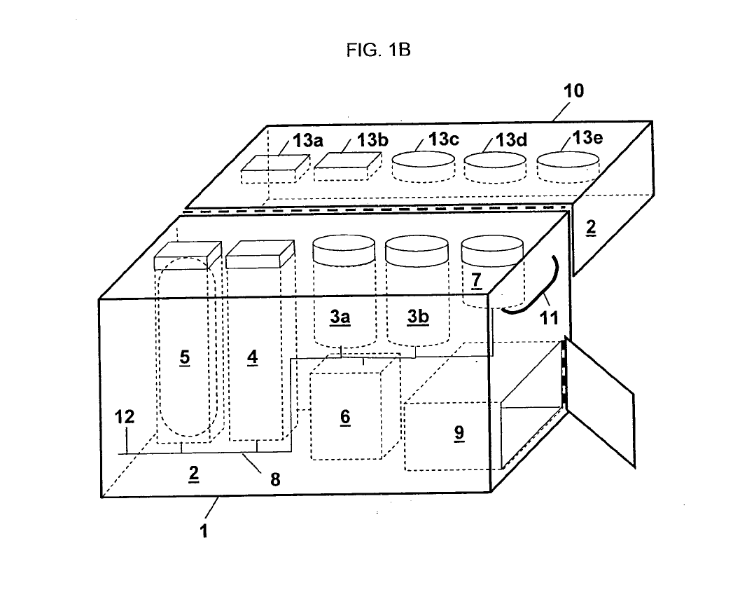

FIGS. 1A and 1B shows a cross-sectional view of the system according to an example embodiment of the invention, wherein FIG. 1A gives a two-dimensional view and FIG. 1B gives a three-dimensional view. The reference numbers for all of the figures, including 1A and 1B, are consistent throughout the drawings. FIGS. 1A and 1B depict the apparatus and the system, wherein the system comprises the apparatus plus an electrical power supply.

In the embodiment depicted in FIGS. 1A and 1B, the system is comprised of an external case 1, and thermal and shock insulation 2. The external case and insulation are made of materials that can withstand rigorous treatment while protecting the payload contents and temperature regulating components of the system, such as is needed when being transported by an express freight service. Further, the insulation is made of materials that serve to insulate the internal temperature of the payload compartments 3a and 3b so that the predetermined temperature can be maintained. Such materials may include, but are not limited to expanded resin foams such as polystyrene foam, polyurethane foam; and silicon aerogel.

Still referring to FIGS. 1A and 1B, an electrical power supply 4 is included in the system, as is a liquid refrigerant pressure vessel 5. Including both an electrical power supply and a liquid refrigerant pressure vessel provides the system with increased capabilities.

The embodiment depicted in FIGS. 1A and 1B further provides a temperature data recorder and/or temperature control mechanism 6. In one example, the temperature control mechanism can be a digital or mechanical thermostat. In another example, the temperature data recorder and/or temperature control mechanism 6 is a digital microprocessor component to control temperature regulation functions.

A user interface 7 provides the user with the ability to program the system by selecting the predetermined temperature condition to be utilized with the selected payload. The system is reprogrammable, so the user can reprogram the temperature condition each time the system is used, if desired. In some embodiments, the system defaults to the prior temperature condition. In some embodiments, the system prompts the user to enter the desired temperature condition.

The user interface 7 provides an interface for selecting a target temperature for each of compartments 3a and 3b, and an amount of time to maintain each target temperature. The target temperature options include a setting for allowing a compartment to be latent, so that no energy or refrigerant is expended on heating or cooling a compartment that is not carrying an item. Thus, in one example, a user communicates via the user interface 7 that the desired temperature condition for compartment 3a is −20° C. for 48 hours, while the desired temperature condition for compartment 3b is “latent”. In another example, a user sets the desired temperature condition for compartment 3a to 37° C. for 2 hours followed by 4° C. for 22 hours, while the desired temperature condition for compartment 3b is set to −70° C. for 24 hours.

Note that while in some instances the payload items in different compartments are inserted into and removed from the compartments at the same time, this is not required. In some embodiments, the apparatus is used to hold samples for different amounts of time. Therefore, in yet another example, a user sets the desired temperature condition for compartment 3a to 37° C. for 2 hours followed by 4° C. for 22 hours, while the desired temperature condition for compartment 3b is set to −70° C. for 72 hours.

Attached to the user interface 7 is the temperature detection and control mechanism 8, which connects the user interface 7 (where the temperature condition is selected) to the compartments 3a and 3b, the temperature data recorder and temperature control mechanism 6, the electrical power supply 4 and the liquid refrigerant pressure vessel 5.

Also included in the embodiment depicted in FIGS. 1A and 1B is a non temperature-controlled, or ambient, compartment with a door 9, a hinged or removable lid 10 (made of thermal and shock insulating materials), and carrying handles 11. The lid 10 includes accommodations 13a-13e for each of the payload compartments 3a and 3b, the electrical power supply 4, the liquid refrigerant pressure vessel 5, and the user interface 7.

The embodiment shown in FIGS. 1A and 1B further includes a connector 12 for connecting to an external refrigerant or electrical power supply. Thus, it can be seen that embodiments of the present invention, such as the one shown FIGS. 1A and 1B, can be equipped to be both self-contained and to be connectable to external refrigerant and/or electrical power supplies. This is a very useful feature for allowing connection of the apparatus to an external refrigerant or electrical power supply to, for example, pre-heat or pre-cool the compartments, or to save on-board resources until the apparatus is handed over to a shipping carrier for transport.

The exemplary embodiment of the apparatus and system depicted in FIGS. 1A and 1B can be altered and will still fall within the scope of the present invention. In some embodiments, the liquid refrigerant pressure vessel 5 is replaced with a Peltier device, enabling both heating and cooling of the compartments 3a and 3b. In other embodiments, the liquid refrigerant pressure vessel 5 is replaced with an electrical resistance heater for heating compartments 3a and 3b. In still other embodiments, the apparatus or system is comprised of the liquid refrigerant pressure vessel 5 and a Peltier device. In further embodiments, the apparatus or system is comprised of the liquid refrigerant pressure vessel 5 and an electrical resistance heater. In some embodiments, the system and apparatus depicted in FIGS. 1A and 1B are reusable.

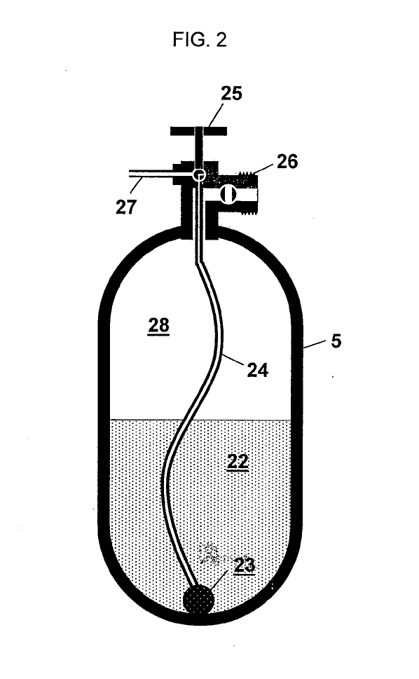

FIG. 2 depicts a cross-sectional view of a refrigerant storage pressure vessel as found in some embodiments of the invention and as might be used in some embodiments of the system and apparatus depicted in FIG. 1 at reference number 5. The refrigerant storage pressure vessel 5 shown in FIG. 2 contains liquid phase refrigerant 22 and gaseous phase refrigerant 28. Remaining in the liquid phase refrigerant 22 is a weighted intake 23, which is connected to a flexible siphon tube 24. The weighted intake 23 will keep the flexible siphon tube 24 in the liquid phase refrigerant 22 because the weighted intake 23 and the liquid phase refrigerant 22 will move with the pull of gravity. The flexible siphon tube 24 runs to a refrigerant supply valve 25, which feeds the refrigerant to the temperature maintenance mechanism 27. The refrigerant fill valve and adapter 26 is used to fill the empty pressure vessel with a supply of liquid refrigerant before use of the apparatus.

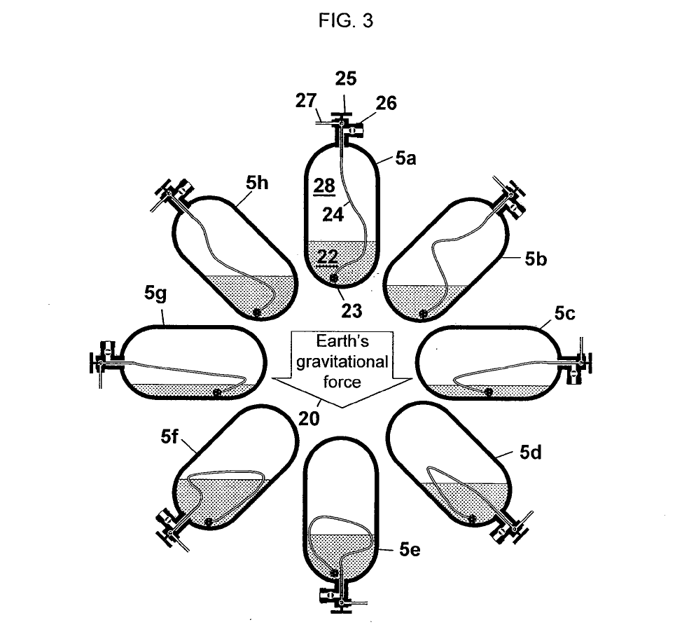

FIG. 3 depicts a cross-sectional view of a refrigerant storage pressure vessel 5 in eight possible different spatial positions 5a-5h according to example embodiments of the invention and as might be used in some embodiments of the system and apparatus depicted in FIGS. 1 and 2 at reference number 5. As can be seen from FIG. 3, the weighted intake 23 and the flexible siphon tube 24 adjust with the pull of gravity, as does the liquid phase refrigerant 22. Arrow 20 represents the direction of gravity's pull. Because the positions of the weighted intake 23, the flexible siphon tube 24, and the liquid phase refrigerant 22 all adjust together to the pull of gravity on the liquid refrigerant pressure vessel 5, the weighted intake stays in the liquid phase refrigerant 22, no matter what the spatial orientation of the liquid refrigerant pressure vessel 5, allowing liquid refrigerant to be drawn into the siphon tube no matter what the spatial orientation of the apparatus. This feature also helps to improve efficiency by enabling much of the liquid phase refrigerant 22 to get into the flexible siphon tube and thus be available for use in the system.

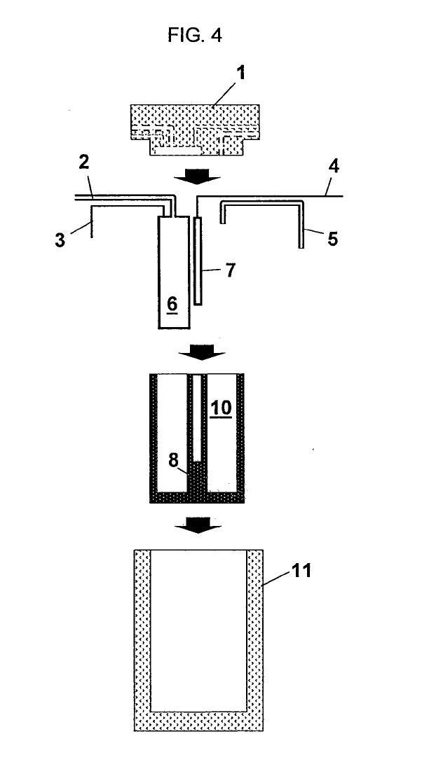

FIG. 4 depicts an exploded, two-dimensional, cross-sectional view of a payload container that fits within an apparatus compartment according to example embodiments of the invention. A double-wall, vacuum-filled closure 1 is constructed with accommodations for a liquid refrigerant supply tube 2, an expansion valve control and power supply 3, an electrical lead for resistance heater with temperature probe 4, and a gaseous (evaporated) refrigerant exit tube 5. A liquid refrigerant evaporator 6 and an electrical resistance heater with temperature probe 7 are placed in a payload compartment 10 along with a gas-porous payload container insert and heat exchanger 8 with accommodations for the liquid refrigerant evaporator 6 and the electrical resistance heater with temperature probe 7.

In some embodiments, the insert and heat exchanger 8 is comprised of a solid or porous metallic, plastic or ceramic material. In some embodiments, the insert and heat exchanger 8 is comprised of a metallic, plastic or ceramic material of high thermal density. In some embodiments the metallic material may be sintered aluminum or stainless steel or brass insert to optimize the efficiency of heat exchange between the sample and the heating source such as electrical resistance heater or cooling source such as refrigerant evaporator.

A double-wall, vacuum housing 11 is constructed to accommodate all of the above and be securely closed. One example of a double-wall vacuum housing 11 is a Thermos® or Dewar flask, modified to accommodate the components as shown in FIG. 4.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. Additionally, comparative, quantitative terms such as “less” and “greater”, are intended to encompass the concept of equality, thus, “less” can mean not only “less” in the strictest mathematical sense, but also, “less than or equal to.”

It should also be pointed out that references may be made throughout this disclosure to figures and descriptions using terms such as “top”, “bottom”, “side”, “within”, “on”, and other terms which imply a relative position of a structure, portion or view. These terms are used merely for convenience and refer only to the relative position of features as shown from the perspective of the reader. An element that is placed or disposed atop another element in the context of this disclosure can be functionally in the same place in an actual product but be beside or below the other element relative to an observer due to the orientation of a device or equipment. Any discussions which use these terms are meant to encompass various possibilities for orientation and placement.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

1. A self-contained temperature controlled apparatus comprising:
at least one compartment;
a predetermined temperature condition for the compartment;
a sensor for detecting the temperature of the compartment; and
at least one device for controlling the temperature of the compartment so that the predetermined temperature condition is met;
wherein the apparatus optionally comprises an on-board electrical power source.

2. The apparatus of claim 1, wherein the predetermined temperature condition includes at least one target temperature and a unit of time for maintaining the target temperature.

3. The apparatus of claim 1, wherein there are at least two compartments and wherein the temperature condition of each of the at least two compartments is independently controlled.

4. The apparatus of claim 1, wherein the device for controlling the temperature condition is comprised of at least one of the group consisting of a liquid refrigerant evaporator, an electrical resistance heater, a heat exchange medium and a Peltier device.

5. The apparatus of claim 4 wherein the device for controlling the temperature condition further comprises a liquid refrigerant stored in a pressure vessel within the apparatus.

6. The apparatus of claim 5 wherein the liquid refrigerant in the pressure vessel supplies liquid refrigerant to the evaporator at ambient temperature.

7. The apparatus of claim 6 wherein the pressure vessel comprises an internal flexible siphon tube and a weighted intake.

8. The apparatus of claim 5, wherein the refrigerant is selected from the group consisting of liquid carbon dioxide and supercritical carbon dioxide.

9. The apparatus of claim 1, further comprising a component for collecting and storing digital temperature data from the compartment.

10. The apparatus of claim 1, further comprising a digital microprocessor component to control temperature regulation functions.

11. The apparatus of claim 1, wherein the compartment holds a perishable item.

12. The apparatus of claim 11, wherein the perishable item is selected from the group consisting of food, biological samples, medications, therapeutic agents, diagnostic agents, antisera, antibodies, blood products, vaccines, DNA therapies, eggs, semen, fertilized embryos, human cell lines, animal cell lines, and tissue samples for diagnostic or therapeutic use.

13. A self-contained temperature controlled apparatus comprising:
at least one compartment;
means for predetermining a temperature condition for the compartment;
means for detecting the temperature of the compartment; and
means for controlling the temperature of the compartment so that the predetermined temperature condition is met.

14. A method of using a self-contained temperature controlled apparatus, comprising:
providing at least one compartment;
placing at least one item in the compartment;
providing a predetermined temperature condition for the compartment;
detecting the temperature of the compartment; and
adjusting the detected temperature of the compartment to meet the predetermined temperature condition;
wherein the apparatus optionally comprises an on-board electrical power source.

15. The method of claim 14, wherein the temperature condition includes a target temperature and a unit of time for maintaining the target temperature.

16. The method of claim 14, further comprising collecting and storing temperature data from the compartment.

17. A system for operating a self-contained temperature controlled apparatus comprising:
at least one compartment;
a predetermined temperature condition for the compartment;
a sensor for detecting the temperature of the compartment;
at least one device for controlling the temperature of the compartment so that the predetermined temperature condition is met; and
optionally, an electrical power source.

18. The system of claim 17, wherein the electrical power source is at least one of an on-board source or a connection for connecting to an external source.

19. The system of claim 17, wherein the electrical power supply is a rechargeable battery.

20. The system of claim 17, wherein the device for controlling the temperature condition is comprised of at least one of the group consisting of a liquid refrigerant evaporator, an electrical resistance heater, a heat exchange medium and a Peltier device.

21. The system of claim 20, wherein the refrigerant of the liquid refrigerant evaporator is selected from the group consisting of liquid carbon dioxide, supercritical carbon dioxide, dry ice, liquid nitrogen and halocarbons.

22. The system of claim 20, wherein the refrigerant is a liquid refrigerant stored in a pressure vessel comprising an internal flexible siphon tube and a weighted intake.

23. The system of claim 20 further comprising a connection for connecting to an external source of the refrigerant.

24. The apparatus of claim 4 further comprising a connection for connecting to an external source of the refrigerant.
